(19) United States
(12) Patent Application Publication
(10) Pub. No.: US 2024/0365882 A1
(43) Pub. Date: Nov. 7, 2024

(54) AEROSOL DELIVERY DEVICE WITH AN ACCESS KEY

(71) Applicant: Imperial Tobacco Limited, Bristol (GB)

(72) Inventors: Jonathan Marchbank, Liverpool Merseyside (GB); Thomas Sudlow, Liverpool Merseyside (GB); David Thomas, Liverpool Merseyside (GB); Oliver Talbot, Liverpool Merseyside (GB)

(21) Appl. No.: 18/691,017

(22) PCT Filed: Sep. 9, 2022
(86) PCT No.: PCT/EP2022/075135

§ 371 Date: Mar. 11, 2024

(30) Foreign Application Priority Data
Sep. 15, 2021 (EP) 21196964.7

(51) Int. Cl. A24F 40/65; A24F 40/53; H04L 9/32; H04W 12/069

(52) U.S. Cl. CPC A24F 40/65; A24F 40/53; H04L 9/3226; H04W 12/069

(57) ABSTRACT

The present disclosure relates to an aerosol delivery device (102) comprising a communication interface (124) configured to communicate with a mobile device (300), a user interface (160) configured to receive a user input sequence, and a memory (122) configured to store an access key (166). The device (102) further comprises a controller (120) configured to compare a user input sequence received by the user interface (160) with the stored access key (166). and control communication between the aerosol delivery device (102) and the mobile device (300) based on the comparison. Also disclosed is an access system for managing access to an aerosol delivery device. The system comprises a server (400) configured to store a server key (404) that corresponds to the access key (166) of the aerosol delivery device (102), the server (400) further configured to receive user verification data. determine whether the user verification data meets a user verification criteria. and provide the server key (404). upon request. if the user verification data meets the user verification criteria. Also disclosed is a method of allocating user access keys using a mapping function.

### TECHNICAL FIELD

The present disclosure relates to an aerosol delivery device and an aerosol delivery system such as a smoking substitute device/system. The present disclosure also relates to an access management system and a method of allocating access keys to a plurality of aerosol delivery devices.

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Combustion of organic material such as tobacco is known to produce tar and other potentially harmful by-products. There have been proposed various smoking substitute systems in order to avoid the smoking of tobacco.

Such smoking substitute systems can form part of nicotine replacement therapies aimed at people who wish to stop smoking and overcome a dependence on nicotine.

Smoking substitute systems, which may also be known as electronic nicotine delivery systems, may comprise electronic systems that permit a user to simulate the act of smoking by producing an aerosol, also referred to as a “vapour”, which is drawn into the lungs through the mouth (inhaled) and then exhaled. The inhaled aerosol typically bears nicotine and/or flavourings without, or with fewer of, the odour and health risks associated with traditional smoking.

In general, smoking substitute systems are intended to provide a substitute for the rituals of smoking, whilst providing the user with a similar experience and satisfaction to those experienced with traditional smoking and tobacco products.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories. Some smoking substitute systems are designed to resemble a traditional cigarette and are cylindrical in form with a mouthpiece at one end. Other smoking substitute systems do not generally resemble a cigarette (for example, the smoking substitute device may have a generally box-like form).

There are a number of different categories of smoking substitute systems, each utilising a different smoking substitute approach. A smoking substitute approach corresponds to the manner in which the substitute system operates for a user.

One approach for a smoking substitute system is the so-called “vaping” approach, in which a vaporisable liquid, typically referred to (and referred to herein) as “e-liquid”, is heated by a heater to produce an aerosol vapour which is inhaled by a user. An e-liquid typically includes a base liquid as well as nicotine and/or flavourings. The resulting vapour therefore typically contains nicotine and/or flavourings. The base liquid may include propylene glycol and/or vegetable glycerine.

A typical vaping smoking substitute system includes a mouthpiece, a power source (typically a battery), a tank or liquid reservoir for containing e-liquid, as well as a heater. In use, electrical energy is supplied from the power source to the heater, which heats the e-liquid to produce an aerosol (or “vapour”) which is inhaled by a user through the mouthpiece.

Vaping smoking substitute systems can be configured in a variety of ways. For example, there are “closed system” vaping smoking substitute systems which typically have a heater and a sealed tank which is pre-filled with e-liquid and is not intended to be refilled by an end user. One subset of closed system vaping smoking substitute systems include a device which includes the power source, wherein the device is configured to be physically and electrically coupled to a component including the tank and the heater. In this way, when the tank of a component has been emptied, the device can be reused by connecting it to a new component. Another subset of closed system vaping smoking substitute systems are completely disposable, and intended for one-use only.

There are also “open system” vaping smoking substitute systems which typically have a tank that is configured to be refilled by a user, so the system can be used multiple times.

An example vaping smoking substitute system is the myblu™ e-cigarette. The myblu™ e cigarette is a closed system which includes a device and a consumable component. The device and consumable component are physically and electrically coupled together by pushing the consumable component into the device. The device includes a rechargeable battery. The consumable component includes a mouthpiece, a sealed tank which contains e-liquid, as well as a vaporiser, which for this system is a heating filament coiled around a portion of a wick which is partially immersed in the e-liquid. The system is activated when a microprocessor on board the device detects a user inhaling through the mouthpiece. When the system is activated, electrical energy is supplied from the power source to the vaporiser, which heats e-liquid from the tank to produce a vapour which is inhaled by a user through the mouthpiece.

Another example vaping smoking substitute system is the blu PRO™ e-cigarette. The blu PRO™ e cigarette is an open system which includes a device, a (refillable) tank, and a mouthpiece. The device and tank are physically and electrically coupled together by screwing one to the other. The mouthpiece and refillable tank are physically coupled together by screwing one into the other, and detaching the mouthpiece from the refillable tank allows the tank to be refilled with e-liquid. The system is activated by a button on the device. When the system is activated, electrical energy is supplied from the power source to a vaporiser, which heats e-liquid from the tank to produce a vapour which is inhaled by a user through the mouthpiece.

An alternative to the “vaping” approach is the so-called Heated Tobacco (“HT”) approach in which tobacco (rather than an e-liquid) is heated or warmed to release vapour. HT is also known as “heat not burn” (“HNB”). The tobacco may be leaf tobacco or reconstituted tobacco. In the HT approach the intention is that the tobacco is heated but not burned, i.e. the tobacco does not undergo combustion.

The heating, as opposed to burning, of the tobacco material is believed to cause fewer, or smaller quantities, of the more harmful compounds ordinarily produced during smoking. Consequently, the HT approach may reduce the odour and/or health risks that can arise through the burning, combustion and pyrolytic degradation of tobacco.

A typical HT smoking substitute system may include a device and a consumable component. The consumable component may include the tobacco material. The device and consumable component may be configured to be physically coupled together. In use, heat may be imparted to the tobacco material by a heating element of the device, wherein airflow through the tobacco material causes components in the tobacco material to be released as vapour. A vapour may also be formed from a carrier in the tobacco material (this carrier may for example include propylene glycol and/or vegetable glycerine) and additionally volatile compounds released from the tobacco. The released vapour may be entrained in the airflow drawn through the tobacco.

As the vapour passes through the consumable component (entrained in the airflow) from the location of vaporization to an outlet of the component (e.g. a mouthpiece), the vapour cools and condenses to form an aerosol for inhalation by the user. The aerosol may contain nicotine and/or flavour compounds.

One feature in some smoking substitute systems is the ability for the device to communicate with external (e.g. mobile) devices. This may, for example, allow control, of a smoking substitute device from the external device. One issue with such an arrangement, however, is the potential for inadvertently providing access to the smoking substitute device, or the potential for a malicious operator to gain access to the smoking substitute device.

Accordingly, there is a need for an improved aerosol delivery device/system which addresses at least some of the problems of the known devices and systems.

### SUMMARY

According to a first aspect, there is provided an aerosol delivery device comprising:
a communication interface configured to communicate with a mobile device;
a user interface configured to receive a user input sequence;
a memory configured to store an access key; and
a controller configured to compare a user input sequence received by the user interface with the stored access key, and control communication between the aerosol delivery device and the mobile device based on the comparison.

Control of communication based on the comparison between the user input sequence and the stored access key helps to secure the aerosol delivery device against connection with e.g. a potentially malicious device (or a device operated by a malicious operator). By requiring the user to provide a user input sequence using the user interface of the aerosol delivery device (and not the mobile device), anyone attempting communication with the aerosol delivery device must be in possession of the aerosol delivery device.

Optional features will now be set out. These are applicable singly or in any combination with any aspect.

Controlling communication with the mobile device may comprise permitting and/or restricting communication with the mobile device.

Restricting communication may comprise restricting communication of data from the aerosol delivery device to the mobile device. For example, restricting communication may comprise not acting on a request from the mobile device (e.g. for data stored in the memory of the aerosol delivery device).

Permitting communication with the mobile device may comprise allowing control of the aerosol delivery device by the mobile device. Accordingly, restricting communication with the mobile device may comprise, for example, restricting control of the aerosol delivery device by the mobile device. The communication interface may be configured to receive control requests from the mobile device, each control request requesting the controller to e.g. control an operation of the aerosol delivery device.

Restricting control may therefore comprise, for example, not acting upon a control request received from the mobile device.

Controlling communication between the aerosol delivery device and the mobile device may comprise communicating a status message to the mobile device. The status message may instruct the mobile device to permit or restrict communication between the mobile device and the aerosol delivery device.

The comparison performed by the controller may comprise checking whether the user input sequence corresponds to (e.g. matches) the stored access key. Where the user input sequence does correspond to the stored access key, the controller may permit communication with the mobile device. Where the user input sequence does not correspond to the stored access key, the controller may restrict communication with the mobile device.

The user interface may comprise a device motion detector. The device motion detector may be an accelerometer. Thus, the accelerometer may be configured to detect movement of the aerosol delivery device.

The stored access key may be representative of a movement of the device (i.e. a gesture) as detected by the accelerometer. Thus, the user interface may be configured to detect (e.g. via the accelerometer) a gesture and that gesture may be compared (by the controller) with the access key stored in the memory (i.e. the stored gesture). The stored gesture may comprise a combination of movements of the device. The stored gesture may comprise translation of the device along a predetermined path.

The stored gesture may comprise rotation of the device. Hence, the stored gesture may comprise a combination of one or more translations and one or more rotations.

The user interface may comprise a touch sensor. The touch sensor may be configured to detect physical contact (e.g. by a user) with the aerosol delivery device. The user interface may comprise a button (e.g. a press button).

The stored access key may be representative of a sequence of taps on the device by a user. Thus the user interface may be configured to detect a tap sequence (e.g. one or more physical contacts with the device by a user) and that tap sequence may be compared with the stored access key (i.e. the stored tap sequence). The tap sequence may be detected by the accelerometer. The tap sequence may be detected by the touch sensor. The tap sequence may be detected by the button.

The stored tap sequence may comprise a plurality of tap events (i.e. each being a tap on the aerosol delivery device). The stored tap sequence may comprise tap events of differing length (e.g. a combination of short taps and holds). The stored tap sequence may comprise non-tap events (i.e. periods between each tap where no physical contact is detected). The stored tap sequence may comprise non-tap events of differing length.

The stored access key may be representative of a combination of a tap sequence and movement of the device. For example, the stored access key may be representative of a sequence of taps followed by a gesture (or vice-versa).

The stored access kay may be representative of a sequence of characters (e.g. an alphanumeric sequence). The user interface may comprise e.g. a touchscreen or buttons that allow the input of such a sequence.

The controller may be configured, upon receipt of a communication request, to store mobile device data corresponding to the mobile device in the memory (e.g. a MAC address, device name, etc.). The controller may be configured, upon receipt of a user input sequence corresponding to the stored access key, identify the stored mobile device data as a known mobile device. The controller may be configured, upon receipt of a subsequent connection with a mobile device identified as a known mobile device, permit communication between the mobile device and the aerosol delivery device.

The controller may be configured to, upon receipt of a user input sequence corresponding to (e.g. matching) the stored access key, permit communication between the communication interface and the mobile device. For example, the controller may be configured to permit control of the aerosol delivery device by the mobile device and/or may permit the transmission of data from the aerosol delivery device (e.g. from the memory of the aerosol delivery device) to the mobile device.

The user interface may be configured to communicate information to a user. The user interface may comprise one or more of e.g. a display, haptic feedback device, lights (e.g. LEDs) for communicating information to a user. The controller may be configured to control the user interface to communicate information to a user. The controller may be configured to, upon receipt of a communication request from the mobile device, control the user interface to indicate the receipt of the communication request to a user. This may, for example, indicate to a user to provide a user input sequence that corresponds to the stored access key.

The controller may be configured to control the user interface to indicate to a user that communication with a mobile device has been permitted or restricted.

The communication interface may be configured to communicate wirelessly (e.g. via Bluetooth™ or WiFi) with the mobile device. To this end, the wireless interface may include a Bluetooth® antenna. The communication interface may be configured to communicate with an application (or “app”) installed on the mobile device, e.g. via a suitable wireless interface of the mobile device. The mobile device may be a mobile phone or tablet, for example.

The communication interface may be configured to communicate with the mobile device via a network, which may include a cellular network and/or the internet.

According to a second aspect, there is provided a device access system for managing access to an aerosol delivery device, the system comprising:
an aerosol delivery device configured to communicate with a mobile device, the aerosol delivery device comprising a controller configured to control communication with the mobile device based on a comparison between a user input and an access key that is stored by the aerosol delivery device; and
a server configured to store a server key that corresponds to the access key of the aerosol delivery device, the server further configured to receive user verification data, determine whether the user verification data meets a user verification criteria, and provide the server key, upon request, if the user verification data meets the user verification criteria.

The server provides means for a user (e.g. via a client) to acquire the access key of the device. As is discussed further below, such access may, for example, be in the form of permitted communication between the aerosol delivery device and the mobile device. By restricting access to the server key by way of a user verification process, however, the server ensures that only specific users may access the server key. In this way, the type of user able to access enable communication between the aerosol delivery device and the mobile device may be moderated.

Optional features will now be set out. These are applicable singly or in any combination with any aspect.

The user verification criteria may comprise a minimum user age. Thus, for example, the user verification data may be indicative of a user's age. The server may be configured to consult one or more external databases (e.g. by making a request to an external server) to determine whether the user verification data meets the user verification criteria.

In one example, the user verification data comprises information identifying a user and the server may be configured to submit a request, containing the user identifying information, to an external server. The external server may be configured to respond with data representative of the user's age, or indicative of whether the user meets a minimum age requirement.

The server may be configured to store the result of the user verification assessment. Thus, for example, a user may complete the user verification assessment (i.e. by providing the user verification data) and subsequently request the server key.

The server may be configured to store a user account comprising user account information. The user account information may comprise a user identifier and a user password. The server may be configured to associate the user verification assessment result with a user account. The server may be configured to associate the user account with a server key. Thus, for example, a user may access a user account, by provision of the corresponding user account information, and may retrieve the server key, if the user verification assessment has previously been completed successfully (i.e. previously provided user verification data met the user verification criteria).

The server key may comprise an alphanumeric sequence. The server key may comprise instructions for performing a user input sequence, such as a gesture or a sequence of taps.

The system may comprise a client configured to communicate user verification data to the server. The client may be configured to send a request for a server key to the server and may be configured to receive the server key from the server. The client may be the mobile device.

Controlling communication with the mobile device may be the same as that discussed above with respect to the device of the first aspect. Thus, controlling communication with the mobile device may comprise permitting and/or restricting communication with the mobile device.

Restricting communication may comprise restricting communication of data from the aerosol delivery device to the mobile device. For example, restricting communication may comprise not acting upon a request from the mobile device (e.g. for data stored in the memory of the aerosol delivery device).

Restricting communication with the mobile device may comprise, for example, restricting control of the aerosol delivery device by the mobile device. The aerosol delivery device may be configured to receive control requests from the mobile device, each control request requesting the controller to e.g. control an operation of the aerosol delivery device. Restricting control may comprise, for example, not acting upon a control request received from the mobile device.

Controlling communication may comprise communicating a status message to the mobile device. The status message may instruct the mobile device to permit or restrict communication between the mobile device and the aerosol delivery device.

The comparison performed by the controller may comprise checking whether the user input corresponds to (e.g. matches) the stored key. Where the user input does correspond to the stored key, the controller may permit communication with and/or control by the mobile device. Where the user input sequence does not correspond to the stored access key, the controller may restrict communication with the mobile device.

According to a third aspect, there is provided a method of allocating access keys to a plurality of aerosol delivery devices, the method comprising, for each aerosol delivery device:
assigning the device a unique identifier key (UIK);
applying a mapping function to the UIK to generate a corresponding access key; and
storing the access key in a memory of the aerosol delivery device;
wherein the mapping function is the same for each device.

Associating each key with the UIK of the respective device (i.e. via a common mapping function) may simplify management of device security. For example, such an arrangement may reduce the amount of information that must be stored by e.g. a manufacturer or seller. That is, a manufacturer or seller does not need to maintain a database of access key-UIK pairs, because the access key of each device is capable of being determined from the UIK.

Optional features will now be set out. These are applicable singly or in any combination with any aspect.

The method may comprise providing the plurality of aerosol delivery devices. Each device may comprise the memory for storing the access key. Each device may comprise a controller configured to control the device based on a comparison of a user input with an access key (i.e. stored in the memory).

The method may comprise storing the UIK in a memory of the device to which it is assigned. The controller of each device may be configured to retrieve the UIK from the memory. Each device may comprise a user interface, which may be configured to display the UIK to a user (i.e. retrieved by the controller).

The method may comprise applying each UIK to the device to which it is assigned. For example, the method may comprise printing, or forming, the UIK on the device. The UIK may be in the form of a serial number.

The mapping function may comprise a hash function (e.g. a cryptographic hash function (CHF)). In this respect, the mapping function may be a one-way function (such that the UIK (input) is not retrievable from the access key (output)). The mapping function may be deterministic, such that a particular UIK input into the mapping function results in the same output (i.e. access key) every time.

The mapping function may be configured to output an access key of fixed length (i.e. regardless of the length of the input UIK). The mapping function may be configured to output an access key consisting of alphanumeric characters.

The aerosol delivery devices of the third aspect may be as described above with respect to the first aspect. The aerosol delivery devices of the second aspect may have access keys allocated according to the method of the third aspect.

The or each aerosol delivery device of any aspect discussed above may be as described below.

The device may comprise a source of power which may be a battery. The source of power may be a capacitor. The power source may be a rechargeable power source. The device may comprise a charging connection for connection to an external power supply for recharging of the power source within the device.

The aerosol delivery device may comprise a device body for housing the power source and/or other electrical components. The device body may be an elongate body i.e. with a greater length than depth/width. It may have a greater width than depth.

The device body may have a length of between 5 and 30 cm e.g. between 10 and 20 cm such as between 10 and 13 cm. The maximum depth of the device body may be between 5 and 30 mm e.g. between 10 and 20 mm.

The device body may have a front surface that is curved in the transverse dimension. The device body may have a rear surface that is curved in the transverse dimension. The curvatures of the front surface and rear surface may be of the opposite sense to one another. Both front and rear surfaces may be convex in the transverse dimension. They may have an equal radius of curvature.

The radius of curvature of the front surface may be between 10 and 50 mm, preferably between 10 and 40 mm, preferably between 10 and 30 mm, preferably been 10 and 20 mm, more preferably between and 15 mm, more preferably substantially 13.5 mm.

The front and rear surfaces may meet at opposing transverse edges of the device body. This leads to a mandorla-/lemon-/eye-shaped cross sectional shape of the device body.

The transverse edges may have a radius of curvature that is significantly smaller than the radius of curvature of either the front or rear surface. This leads to the transverse edges being substantially “pointed” or “sharp”. The transverse edges may have a radius of curvature in the transverse dimension of less than 10 mm, preferably less than 5 mm, preferably less than 2 mm, preferably less than 1 mm.

The transverse edges may extend substantially the full longitudinal length of the device body. However, in some embodiments, the transverse edges may only extend along a longitudinal portion of the device body.

The device body may have a curved longitudinal axis i.e. curved in a direction between the front and rear faces.

The front and/or rear surface of the device body may include at least one visual user feedback element, for example one or more lights e.g. one or more LEDs. The visual feedback element may form part of the user interface of the device.

In some embodiments, the device body may include an illumination region configured to allow light provided by the visual user feedback element (e.g. one or more lights/LEDs) within the device body to shine through.

The aerosol delivery device may comprise a haptic feedback generation unit (e.g. an electric motor and a weight mounted eccentrically on a shaft of the electric motor).

The controller of the aerosol delivery device may be configured to identify an operation of the device; and control the one or more lights contained within the device body, (e.g. to illuminate the illumination region) based on the operation of the device identified.

The controller may be configured to control the haptic feedback generation unit to generate the haptic feedback in response to the detection of movement of the device by the movement detection unit.

As is set forth above, the device comprises a memory, which may be operatively connected to the controller. The memory may include non-volatile memory. The memory may include instructions which, when implemented, cause the controller to perform certain tasks or steps of a method.

The device may comprise an airflow (i.e. puff) sensor that is configured to detect a puff (i.e. inhalation from a user). The airflow sensor may be operatively connected to the controller so as to be able to provide a signal to the controller that is indicative of a puff state (i.e. puffing or not puffing). The airflow sensor may, for example, be in the form of a pressure sensor or an acoustic sensor.

The controller may control power supply to a vaporiser in response to airflow detection by the sensor. The control may be in the form of activation of the vaporiser in response to a detected airflow.

The device may comprise an electrical connection (e.g. one or more contact pins) for connection of the power source to the vaporiser.

The device may comprise a chassis within the device body and one or more of the electrical components of the device (e.g. one or more of the power source, charging connection, visual feedback element, movement detection unit, haptic feedback generation unit, controller, memory, wireless interface, puff sensor and/or electrical connection) may be mounted on or affixed to the chassis.

In a fourth aspect, there is provided an aerosol delivery system comprising a device according to the first aspect and a component for containing an aerosol precursor.

The component may be an aerosol-delivery (e.g. a smoking substitute) consumable i.e. in some embodiments the component may be a consumable component for engagement with the aerosol-delivery (e.g. a smoking substitute) device to form the aerosol-delivery (e.g. s smoking substitute) system.

The device may be configured to receive the consumable component. The device and the consumable component may be configured to be physically coupled together. For example, the consumable component may be at least partially received in a recess of the device, such that there is snap engagement between the device and the consumable component. Alternatively, the device and the consumable component may be physically coupled together by screwing one onto the other, or through a bayonet fitting.

Thus, the consumable component may comprise one or more engagement portions for engaging with the device.

The consumable component may comprise a vaporiser. The vaporiser may comprise a heating element. Alternatively, the vaporiser may comprise an ultrasonic or flow expansion unit, or an induction heating system.

The consumable component may comprise an electrical interface for interfacing with a corresponding electrical interface of the device. One or both of the electrical interfaces may include one or more electrical contacts (which may extend through the transverse plate of the lower portion of the insert). Thus, when the device is engaged with the consumable component, the electrical interface may be configured to transfer electrical power from the power source to the vaporiser (e.g. heating element) of the consumable component. The electrical interface may also be used to identify the consumable component from a list of known types. The electrical interface may additionally or alternatively be used to identify when the consumable component is connected to the device.

The device may alternatively or additionally be able to detect information about the consumable component via an RFID reader, a barcode or QR code reader. This interface may be able to identify a characteristic (e.g. a type) of the consumable. In this respect, the consumable component may include any one or more of an RFID chip, a barcode or QR code, or memory within which is an identifier and which can be interrogated via the interface.

In other embodiments, the component may be integrally formed with the aerosol-delivery (e.g. a smoking substitute) device to form the aerosol-delivery (e.g. s smoking substitute) system.

In such embodiments, the aerosol former (e.g. e-liquid) may be replenished by re-filling a tank that is integral with the device (rather than replacing the consumable). Access to the tank (for re-filling of the e-liquid) may be provided via e.g. an opening to the tank that is sealable with a closure (e.g. a cap).
The smoking substitute system may comprise an airflow path therethrough, the airflow path extending from an air inlet to an outlet. The air inlet may be provided in the device body. The outlet may be at a mouthpiece portion of the component. In this respect, a user may draw fluid (e.g. air) into and along the airflow path by inhaling at the outlet (i.e. using the mouthpiece portion).

The airflow path passes the vaporiser between the air inlet and the outlet. The vaporiser may be provided in the component.

The airflow path may comprise a first portion extending from the air inlet towards the vaporiser. A second portion of the airflow path passes through the vaporising chamber to a conduit that extends to the outlet. The conduit may extend along the axial centre of the component.

References to “downstream” in relation to the airflow path are intended to refer to the direction towards the outlet/mouthpiece portion. Thus the second portion of the airflow path is downstream of the first portion of the airflow path. Conversely, references to “upstream” are intended to refer to the direction towards the air inlet. Thus the first portion of the airflow path (and the air inlet) is upstream of the second portion of the airflow path (and the outlet/mouthpiece portion).

References to “upper”, “lower”, “above” or “below” are intended to refer to the component when in an upright/vertical orientation i.e. with elongate (longitudinal/length) axis of the component vertically aligned and with the mouthpiece vertically uppermost.

The component may comprise a tank for housing the aerosol precursor (e.g. a liquid aerosol precursor). The aerosol precursor may comprise an e-liquid, for example, comprising a base liquid and e.g. nicotine. The base liquid may include propylene glycol and/or vegetable glycerine.

At least a portion of one of the walls defining the tank may be translucent or transparent.

The conduit may extend through the tank with the conduit walls defining an inner region of the tank. In this respect, the tank may surround the conduit e.g. the tank may be annular.

As discussed above, the air flow path passes the vaporiser between the air inlet and the outlet. The vaporiser may comprise a wick e.g. an elongate wick which may have a cylindrical shape.

The wick may be oriented so as to extend in the direction of the width dimension of the component (perpendicular to the longitudinal axis of the component). Thus the wick may extend in a direction perpendicular to the direction of airflow in the airflow path.

The vaporiser may be disposed in the vaporising chamber. The vaporising chamber may form part of the airflow path.

The wick may comprise a porous material. A portion of the wick may be exposed to airflow in the airflow path. The wick may also comprise one or more portions in contact with liquid aerosol precursor stored in the tank. For example, opposing ends of the wick may protrude into the tank and a central portion (between the ends) may extend across the airflow path so as to be exposed to airflow. Thus, fluid may be drawn (e.g. by capillary action) along the wick, from the tank to the exposed portion of the wick.

The heating element may be in the form of a filament wound about the wick (e.g. the filament may extend helically about the wick). The filament may be wound about the exposed portion of the wick. The heating element is electrically connected (or connectable) to the power source. Thus, in operation, the power source may supply electricity to (i.e. apply a voltage across) the heating element so as to heat the heating element. This may cause liquid stored in the wick (i.e. drawn from the tank) to be heated so as to form a vapour and become entrained in airflow along the airflow path. This vapour may subsequently cool to form an aerosol e.g. in the conduit.

In a fifth aspect there is provided a method of using the aerosol-delivery (e.g. smoking substitute) system according to the second aspect, the method comprising engaging the consumable component with an aerosol-delivery (e.g. smoking substitute) device (as described above) having a power source so as to electrically connect the power source to the consumable component (i.e. to the vaporiser of the consumable component).

The invention includes the combination of the aspects and preferred features described except where such a combination is clearly impermissible or expressly avoided.

### BRIEF DESCRIPTION OF THE DRAWINGS

So that further aspects and features thereof may be appreciated, embodiments will now be discussed in further detail with reference to the accompanying figures, in which:

FIG. 1A is a front schematic view of a smoking substitute system;

FIG. 1B is a front schematic view of a device of the system;

FIG. 1C is a front schematic view of a component of the system;

FIG. 2A is a schematic of the electrical components of the device;

FIG. 2B is a schematic of the parts of the component;

FIG. 3 is a section view of the component;

FIG. 4 is a perspective view of an embodiment of the device;

FIG. 5 is a schematic transverse cross-section view of the device body of FIG. 4;

FIG. 6 is a schematic view of an aerosol delivery device in communication with a mobile device;

FIGS. 7A, 7B and 7C are schematic views of a connection process for connecting the mobile device and aerosol delivery device of FIG. 6.

FIG. 8 is a schematic view of a system for regulating a connection between an aerosol delivery device and a mobile device; and.

FIG. 9 is a flow chart illustrating a method of allocating access keys to a plurality aerosol delivery devices.

### DETAILED DESCRIPTION OF THE EMBODIMENTS

Aspects and embodiments will now be discussed with reference to the accompanying figures. Further aspects and embodiments will be apparent to those skilled in the art.

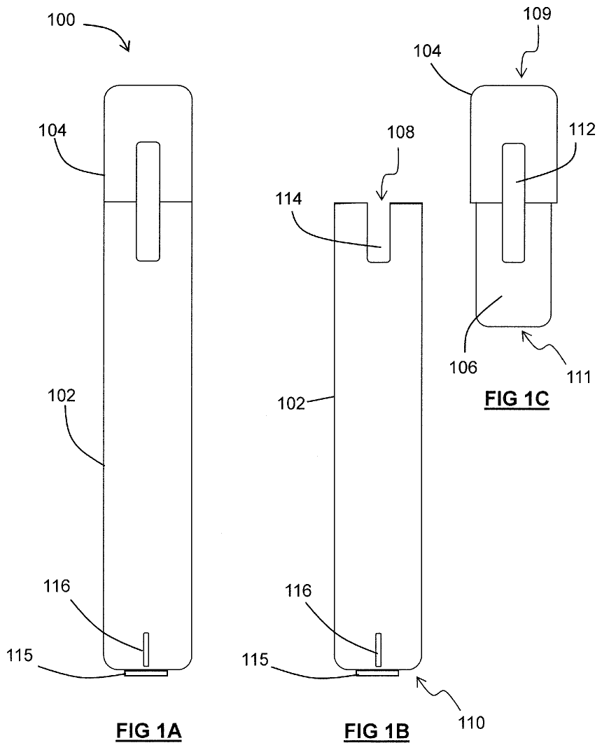

FIG. 1A shows a first embodiment of a smoking substitute system 100. In this example, the smoking substitute system 100 includes a device 102 and a component 104. The component 104 may alternatively be referred to as a “pod”, “cartridge” or “cartomizer”. It should be appreciated that in other examples (i.e. open systems), the device may be integral with the component. In such systems, a tank of the aerosol delivery system may be accessible for refilling the device.

In this example, the smoking substitute system 100 is a closed system vaping system, wherein the component 104 includes a sealed tank 106 and is intended for single-use only. The component 104 is removably engageable with the device 102 (i.e. for removal and replacement). FIG. 1A shows the smoking substitute system 100 with the device 102 physically coupled to the component 104, FIG. 1B shows the device 102 of the smoking substitute system 100 without the component 104, and FIG. 1C shows the component 104 of the smoking substitute system 100 without the device 102.

The device 102 and the component 104 are configured to be physically coupled together by pushing the component 104 into a cavity at an upper end 108 of the device 102, such that there is an interference fit between the device 102 and the component 104. In other examples, the device 102 and the component may be coupled by screwing one onto the other, or through a bayonet fitting.

The component 104 includes a mouthpiece portion at an upper end 109 of the component 104, and one or more air inlets (not shown) in fluid communication with the mouthpiece portion such that air can be drawn into and through the component 104 when a user inhales through the mouthpiece portion. The tank 106 containing e-liquid is located at the lower end 111 of the component 104.

The tank 106 includes a window 112, which allows the amount of e-liquid in the tank 106 to be visually assessed. The device 102 includes a slot 114 so that the window 112 of the component 104 can be seen whilst the rest of the tank 106 is obscured from view when the component 104 is inserted into the cavity at the upper end 108 of the device 102.

The lower end 110 of the device 102 also includes a light 116 (e.g. an LED) located behind a small translucent cover. The light 116 may be configured to illuminate when the smoking substitute system 100 is activated. Whilst not shown, the component 104 may identify itself to the device 102, via an electrical interface, RFID chip, or barcode.

The lower end 110 of the device 102 also includes a charging connection 115, which is usable to charge a battery within the device 102. The charging connection 115 can also be used to transfer data to and from the device, for example to update firmware thereon.

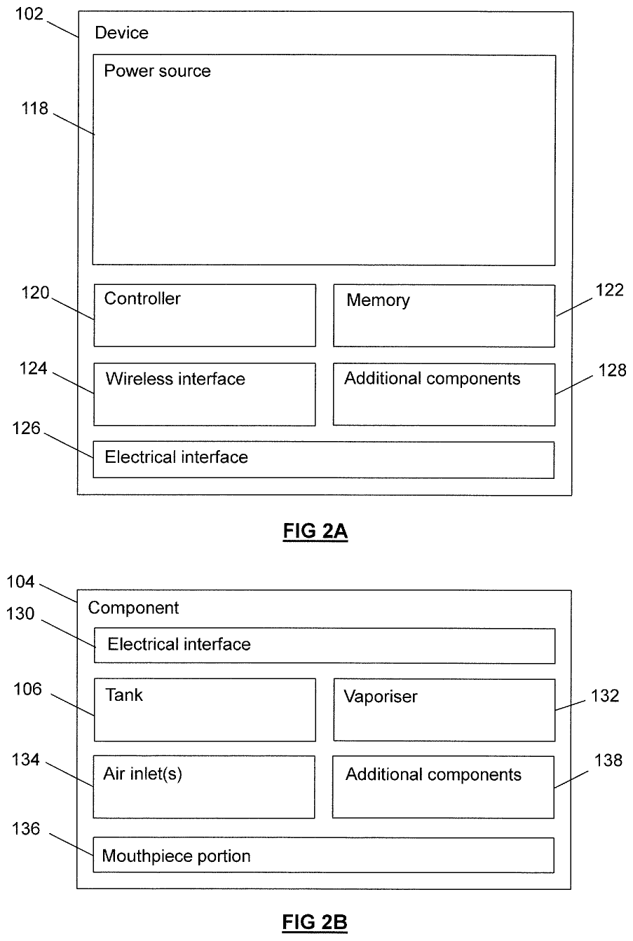

FIGS. 2A and 2B are schematic drawings of the device 102 and component 104. As is apparent from FIG. 2A, the device 102 includes a power source 118, a controller 120, a memory 122, a wireless interface 124, an electrical interface 126, and, optionally, one or more additional components 128.

The power source 118 is preferably a battery, more preferably a rechargeable battery. The controller 120 may include a microprocessor, for example. The memory 122 preferably includes non-volatile memory. The memory may include instructions which, when implemented, cause the controller 120 to perform certain tasks or steps of a method.

The wireless interface 124 is preferably configured to communicate wirelessly with another device, for example a mobile device, e.g. via Bluetooth®. To this end, the wireless interface 124 could include a Bluetooth® antenna. Other wireless communication interfaces, e.g. WiFi®, are also possible. The wireless interface 124 may also be configured to communicate wirelessly with a remote server.

The electrical interface 126 of the device 102 may include one or more electrical contacts. The electrical interface 126 may be located in a base of the aperture in the upper end 108 of the device 102. When the device 102 is physically coupled to the component 104, the electrical interface 126 is configured to transfer electrical power from the power source 118 to the component 104 (i.e. upon activation of the smoking substitute system 100).

The electrical interface 126 may also be used to identify the component 104 from a list of known components. For example, the component 104 may be a particular flavour and/or have a certain concentration of nicotine (which may be identified by the electrical interface 126). This can be indicated to the controller 120 of the device 102 when the component 104 is connected to the device 102. Additionally, or alternatively, there may be a separate communication interface provided in the device 102 and a corresponding communication interface in the component 104 such that, when connected, the component 104 can identify itself to the device 102.

The additional components 128 of the device 102 may comprise the light 116 discussed above.

The additional components 128 of the device 102 also comprises the charging connection 115 configured to receive power from the charging station (i.e. when the power source 118 is a rechargeable battery). This may be located at the lower end 110 of the device 102.

The additional components 128 of the device 102 may, if the power source 118 is a rechargeable battery, include a battery charging control circuit, for controlling the charging of the rechargeable battery. However, a battery charging control circuit could equally be located in a charging station (if present).

The additional components 128 of the device 102 may include a sensor, such as an airflow (i.e. puff) sensor for detecting airflow in the smoking substitute system 100, e.g. caused by a user inhaling through a mouthpiece portion 136 of the component 104. The smoking substitute system 100 may be configured to be activated when airflow is detected by the airflow sensor. This sensor could alternatively be included in the component 104. The airflow sensor can be used to determine, for example, how heavily a user draws on the mouthpiece or how many times a user draws on the mouthpiece in a particular time period.

The additional components 128 of the device 102 may include a user input, e.g. a button. The smoking substitute system 100 may be configured to be activated when a user interacts with the user input (e.g. presses the button). This provides an alternative to the airflow sensor as a mechanism for activating the smoking substitute system 100.

As shown in FIG. 2B, the component 104 includes the tank 106, an electrical interface 130, a vaporiser 132, one or more air inlets 134, a mouthpiece portion 136, and one or more additional components 138.

The electrical interface 130 of the component 104 may include one or more electrical contacts. The electrical interface 126 of the device 102 and an electrical interface 130 of the component 104 are configured to contact each other and thereby electrically couple the device 102 to the component 104 when the lower end 111 of the component 104 is inserted into the upper end 108 of the device 102 (as shown in FIG. 1A). In this way, electrical energy (e.g. in the form of an electrical current) is able to be supplied from the power source 118 in the device 102 to the vaporiser 132 in the component 104.

The vaporiser 132 is configured to heat and vaporise e-liquid contained in the tank 106 using electrical energy supplied from the power source 118. As will be described further below, the vaporiser 132 includes a heating filament and a wick. The wick draws e-liquid from the tank 106 and the heating filament heats the e-liquid to vaporise the e-liquid.

The one or more air inlets 134 are preferably configured to allow air to be drawn into the smoking substitute system 100, when a user inhales through the mouthpiece portion 136. When the component 104 is physically coupled to the device 102, the air inlets 134 receive air, which flows to the air inlets 134 along a gap between the device 102 and the lower end 111 of the component 104.

In operation, a user activates the smoking substitute system 100, e.g. through interaction with a user input forming part of the device 102 or by inhaling through the mouthpiece portion 136 as described above. Upon activation, the controller 120 may supply electrical energy from the power source 118 to the vaporiser 132 (via electrical interfaces 126, 130), which may cause the vaporiser 132 to heat e-liquid drawn from the tank 106 to produce a vapour which is inhaled by a user through the mouthpiece portion 136.

An example of one of the one or more additional components 138 of the component 104 is an interface for obtaining an identifier of the component 104. As discussed above, this interface may be, for example, an RFID reader, a barcode, a QR code reader, or an electronic interface which is able to identify the component. The component 104 may, therefore include any one or more of an RFID chip, a barcode or QR code, or memory within which is an identifier and which can be interrogated via the electronic interface in the device 102.

It should be appreciated that the smoking substitute system 100 shown in FIGS. 1A to 2B is just one exemplary implementation of a smoking substitute system. For example, the system could otherwise be in the form of an entirely disposable (single-use) system or an open system in which the tank is refillable (rather than replaceable).

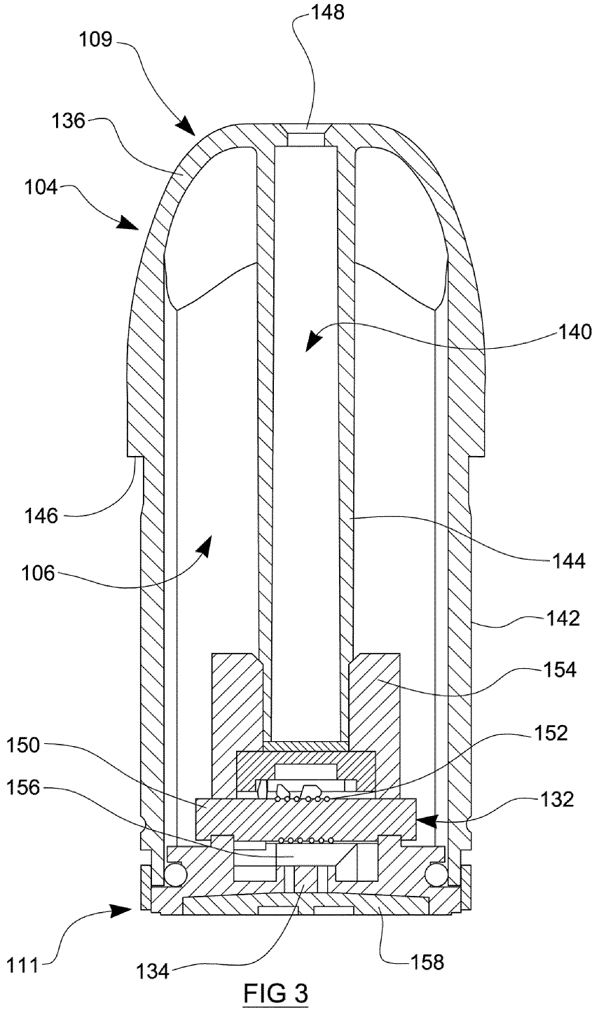

FIG. 3 is a section view of an example of the component 104 described above. The component 104 comprises a tank 106 for storing e-liquid, a mouthpiece portion 136 and a conduit 140 extending along a longitudinal axis of the component 104. In the illustrated embodiment the conduit 140 is in the form of a tube having a substantially circular transverse cross-section (i.e. transverse to the longitudinal axis). The tank 106 surrounds the conduit 140, such that the conduit 140 extends centrally through the tank 106.

A tank housing 142 of the tank 106 defines an outer casing of the component 104, whilst a conduit wall 144 defines the conduit 140. The tank housing 142 extends from the lower end 111 of the component 104 to the mouthpiece portion 136 at the upper end 109 of the component 104. At the junction between the mouthpiece portion 136 and the tank housing 142, the mouthpiece portion 136 is wider than the tank housing 142, so as to define a lip 146 that overhangs the tank housing 142. This lip 146 acts as a stop feature when the component 104 is inserted into the device 102 (i.e. by contact with an upper edge of the device 102).

The tank 106, the conduit 140 and the mouthpiece portion 136 are integrally formed with each other so as to form a single unitary component and may e.g. be formed by way of an injection moulding process. Such a component may be formed of a thermoplastic material such as polypropylene.

The mouthpiece portion 136 comprises a mouthpiece aperture 148 defining an outlet of the conduit 140. The vaporiser 132 is fluidly connected to the mouthpiece aperture 148 and is located in a vaporising chamber 156 of the component 104. The vaporising chamber 156 is downstream of the inlet 134 of the component 104 and is fluidly connected to the mouthpiece aperture 148 (i.e. outlet) by the conduit 140.

The vaporiser 132 comprises a porous wick 150 and a heater filament 152 coiled around the porous wick 150. The wick 150 extends transversely across the chamber vaporising 156 between sidewalls of the chamber 156 which form part of an inner sleeve 154 of an insert 158 that defines the lower end 111 of the component 104 that connects with the device 102. The insert 158 is inserted into an open lower end of the tank 106 so as to seal against the tank housing 142.

In this way, the inner sleeve 154 projects into the tank 106 and seals with the conduit 140 (around the conduit wall 144) so as to separate the vaporising chamber 156 from the e-liquid in the tank 106. Ends of the wick 150 project through apertures in the inner sleeve 154 and into the tank 106 so as to be in contact with the e-liquid in the tank 106. In this way, e-liquid is transported along the wick 150 (e.g. by capillary action) to a central portion of the wick 150 that is exposed to airflow through the vaporising chamber 156. The transported e-liquid is heated by the heater filament 152 (when activated e.g. by detection of inhalation), which causes the e-liquid to be vaporised and to be entrained in air flowing past the wick 150. This vaporised liquid may cool to form an aerosol in the conduit 140, which may then be inhaled by a user.

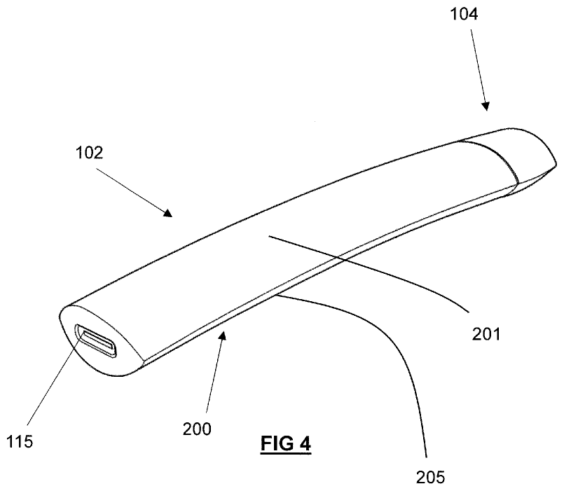

FIG. 4 shows a perspective view of an embodiment of the device 102 engaged with the component 104 at the upper end 108. The device 102 includes a charging connection 115 at the lower end 110.

The front surface 201 of the device body 200 is curved in the transverse dimension. The rear surface 202 of the device body 200 is curved in the transverse dimension. The curvatures of the front surface 201 and rear surface 202 are of the opposite sense to one another. Both front and rear surfaces 201, 202 are convex in the transverse dimension. This leads to a mandorla-/lemon-/eye-shaped cross sectional shape of the device body 200.

The front surface 201 and rear surface 202 meet at two transverse edges 205. The transverse edges 205 have a radius of curvature that is significantly smaller than the radius of curvature of either the front 201 or rear surface 202. This leads to the transverse edges being substantially “pointed” or “sharp”. The transverse edges may have a radius of curvature in the transverse dimension of less than 1 millimetre.

As illustrated in FIG. 4, the transverse edges 205 extend substantially the full longitudinal length of the device body 200.

The front surface 201 of the device body 200 may include an illumination region through which at least one light source may be visible.

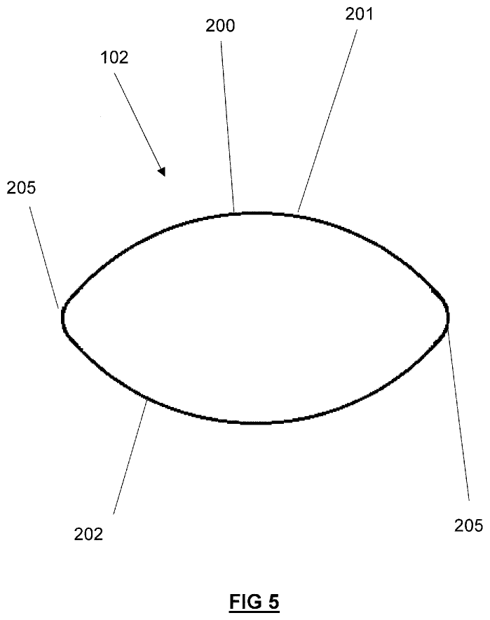

FIG. 5 illustrates a schematic transverse cross section through the device 102 of FIG. 4, in accordance with an embodiment. The front surface 201 and rear surface 202 are shown meeting at the transverse edges 205 on either side of the device body 200. The radius of curvature in the transverse dimension of the front surface 201 is equal to the radius of curvature in the transverse dimension of the rear surface 202.

The radius of curvature of the front surface 201 may be between 10 and 15 mm.

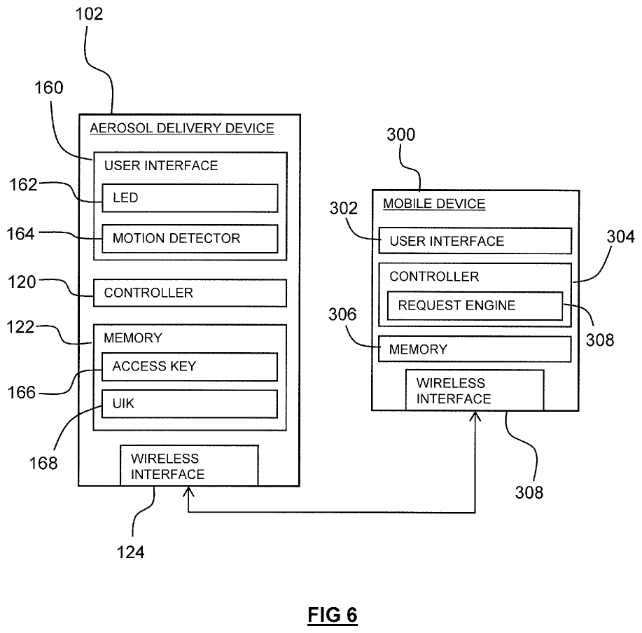

FIG. 6 schematically illustrates an aerosol delivery device 102 operatively connected to a mobile device 300.

The aerosol delivery device 102 is substantially as described above with respect to FIGS. 1A to 5. For clarity, not all features are illustrated (e.g. electrical interface, power source, etc.). The device 102 comprises a user interface 160, which in turn comprises an LED 162 (and may comprise a plurality of LEDs) and a motion detector 164 (e.g. an accelerometer). The device 102 also comprises a memory 122 (as discussed above) that is configured to store an access key 166 and a unique identifier key 168 (i.e. a serial number for the device 102). The device additionally comprises a controller 120 that is operatively connected to each of the user interface 160 and the memory 122.

The controller 120 is also operatively connected to a communication interface, which in the illustrated embodiment is in the form of a wireless interface 124. The wireless interface 124, in this embodiment, comprises a Bluetooth® antenna that allows the device 102 to communicate wirelessly, via a Bluetooth® connection to external devices. As should be appreciated, the communication interface could additionally or alternatively comprise a wired interface.

In the illustrated embodiment, the wireless interface 124 wirelessly connects the device 102 to a mobile device 300. Data may therefore be transferred between the mobile device 300 and the aerosol delivery device 102 (i.e. in both directions) via the wireless connection.

The mobile device 300 may be in the form of a mobile phone, tablet, laptop etc. In the present embodiment, the mobile device 300 comprises a user interface 302, which may comprise a touchscreen display, buttons, speaker, microphone, etc. The mobile device 300 also comprise a memory 306 and a controller 308 (e.g. comprising a microprocessor), which comprises a request engine 308 configured to generate access requests. Like the aerosol delivery device 102, the mobile device 300 comprises a wireless interface 308 (e.g. comprising a Bluetooth® antenna) that allows wireless communication between the mobile device 300 and the aerosol delivery device 102.

In operation, a user may control the mobile device 300 (via the user interface 302) to initiate a connection between the mobile device 300 and the aerosol delivery device 102. In the present embodiment this may be in the form of a pairing operation performed according to a Bluetooth® protocol. The controller 120 of the aerosol delivery device 102 is, however, configured to restrict communication between the mobile device 300 and the aerosol delivery device 102, even after pairing has been completed. This adds an additional level of security beyond that provided by the pairing process. Thus, even if e.g. a malicious operator is able to pair a mobile device with the aerosol delivery device 102 they would still have limited access to the aerosol delivery device 102.

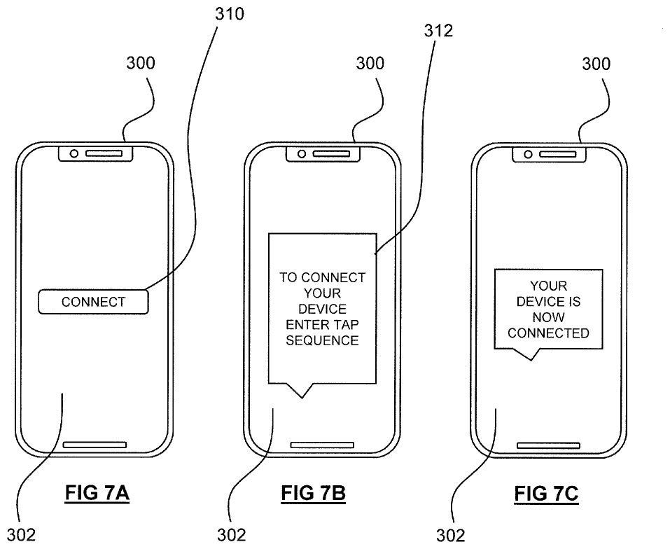

The process of connecting the mobile device 300 to the aerosol delivery device 102 is depicted in FIGS. 7A to 7C. This process may be implemented once an initial link (e.g. a Bluetooth® pairing) is formed between the mobile device 300 and the aerosol delivery device 102. The mobile device 300 includes an application (i.e. app) stored in its memory 306, which is used by a user in order to connect the mobile device 300 to the aerosol delivery device 102. As is depicted in FIG. 7A, the mobile device 300 may present, via a touchscreen of the user interface, a connection screen, which may invite a user to initiate the connection process. The user may interact with the connection screen to start the connection process, by touching a connect button 310 that is presented on the connection screen.

In response, the controller 304 of the mobile device 300 controls the user interface 302 to replace the connection screen with an instruction screen, as shown in FIG. 7B. The instruction screen comprises a message 312 instructing the user to tap the aerosol delivery device 102 in order to complete the connection process. In addition, the request engine 308 of the mobile device 300 sends an access request to the aerosol delivery device 102, via the wireless interfaces 308, 124 (i.e. across the wireless connection). This causes the controller 120 of the aerosol delivery device 102 to begin listening for a user input sequence, in the form of a sequence of taps on the device 102. As should be appreciated, the user input sequence could otherwise be in the form of e.g. a gesture (i.e. a sequence of movements of the aerosol delivery device 102).

The controller 120 compares a sequence of taps, detected by the motion detector 164, to the access key 166 (which is representative of a tap sequence) stored in the memory 122 of the device 102. If the tap sequence matches the access key 166 (i.e. the user has entered the correct sequence), the controller 120 controls the LED 162 of the user interface 160 to illuminate. This indicates to a user that the correct sequence has been entered. The controller 120 also sends a message, via the wireless interface 124, to the mobile device 300 to confirm that the connection process has been completed. In response, the controller 304 of the mobile device 300 controls the user interface 302 to present a completion screen, indicating that the connection has been completed.

Upon completion of the connection, the controller 120 of the aerosol delivery device 102 removes restrictions on communication between the mobile device 300 and the aerosol delivery device 102. Thus, for example, a user may be able to retrieve information from the memory 122 of the aerosol delivery device 102 using the mobile device 300, or may be able to control operation of the aerosol delivery device 102 using the mobile device 300.

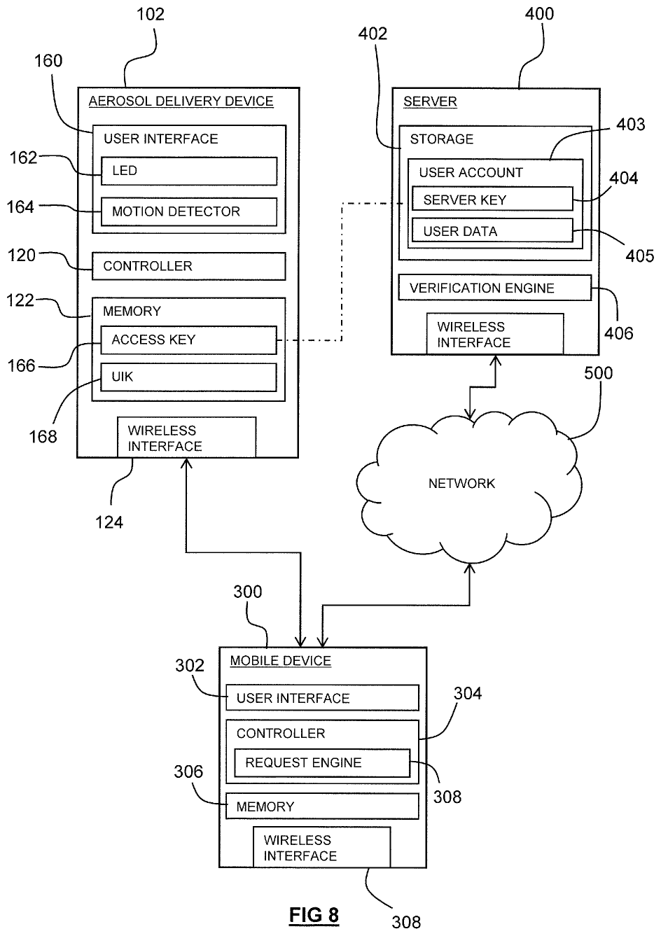

FIG. 8 illustrates a system for regulating a connection between an aerosol delivery device 102 and a mobile device 300. The aerosol delivery device 102 and mobile device 300 may be the same as discussed above with respect to FIG. 6.

In addition to the aerosol delivery device 102 and the mobile device 300, the system further comprises a server 400. The server 400 comprises storage 402 that stores a user account 403 comprising a server key 404 and user data 405. The server 400 also comprises a verification engine 406 and a wireless interface 408, which connects the server to a wireless network 500.

The server key 404 matches the access key 166 of the aerosol delivery device 102 (as is indicated by the dashed line joining the access key 166 and the server key 404). Thus, a user may retrieve the server key 404 from the server 400 in order to enable the user to connect the mobile device 300 to the aerosol delivery device 102. The user can retrieve the server key 404 from the server 400 using the mobile device 300. In order to do so, the user accesses the server 400 from the mobile device 300.

To access the server key 404, the user must first access the user account 403 stored in the storage 402. The user account 403 is created by the user, prior to accessing the server key 404. This involves the user submitting (e.g. via the mobile device 300) user data, which includes (in this embodiment) age verification data. This could be in the form of, for example, an identification card number, driving license, passport number, etc. Based on the data received from the user, the verification engine 406 determines whether the user meets a minimum age requirement. The verification engine 406 may consult an external database (e.g. on an external server via an API) to make such a determination. If the user meets the age verification criteria (i.e. the minimum age requirement) the server 400 creates the user account 403 and the server key 405 with the user account 403.

Subsequently, the user may access the user account 403 (using appropriate user data) and request, e.g. via the mobile device 300, the server key 404 from the server 400. In response, the server 400 provides, via the network 500, the server key 404 to the mobile device 300. The mobile device 300 stores the server key 404 in the memory 306 and, upon request by a user, displays the server key 404 via the user interface 302.

In order to connect the mobile device 300 to the aerosol delivery device 102 (i.e. such that communication is permitted), a process that is similar to that described above (with respect to FIG. 6) is performed. In the present embodiment, however, the access key 166 is not in the form of a user input sequence (e.g. gesture), but is instead an alphanumeric sequence. Thus, when the connection process is initiated, the mobile device 300 requests that the user inputs an alphanumeric sequence. This sequence is communicated to the aerosol delivery device 102, which compares the inputted alphanumeric sequence with the access key 166 stored in the memory 122. If the controller 120 determines that there is a match, restrictions on the communication between the aerosol delivery device 102 and mobile device 300 will be removed. Thus, as is discussed above, the user will be able to retrieve data from the memory 122 of the aerosol delivery device 102 or control an operation of the aerosol delivery device 102 using the mobile device 300.

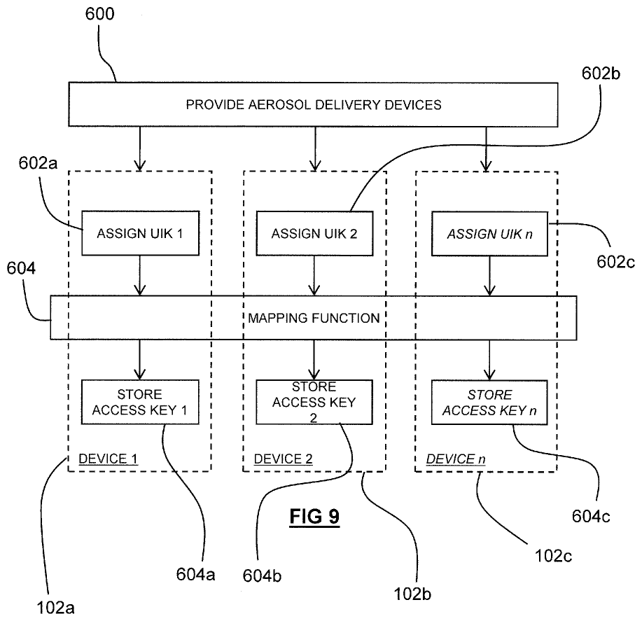

The access key 166 is derived from the unique identifier key 168 of the aerosol delivery device 102. FIG. 9 provides a schematic depicting how this derivation is performed. In particular, this figure illustrates how access keys may be allocated to a plurality of devices 102a, 102b, 102c (e.g. by a manufacturer or seller of the devices 102a, 102b, 102c). This process comprises a first step 600 of providing a plurality of aerosol delivery devices 102a, 102b, 102c (such as those discussed in any of the embodiments above). In a series of second steps 602a, 602b, 602c unique identifier keys (UIKs) are assigned to each of the devices provided in the first step 600 (i.e. one unique identifier key per device 102a, 102b, 102c). In a third step 604, a mapping function is applied to each of the UIKs. As is evident from the figure, the same mapping function is applied to each UIK. The mapping function is in the form of a cryptographic hash function (CHF), which is a one-way deterministic function. The mapping function is configured so as to generate an alphanumeric output of a fixed length. The output of the mapping function applied to each UIK is the access key for the respective device (i.e. to which the UIK is assigned). Hence, in a series of fourth steps 604a, 604b, 604c, each generated access keys is stored in the memory of its respective device 102a, 102b, 102c. In this way, each device 102a, 102b, 102c stores an access key that is unique and that can be generated from the UIK of the device using the common mapping function.

As may be exemplified by briefly referring to the system of FIG. 8, such an arrangement simplifies the management of a plurality of access keys associated with a plurality of devices. In the system of FIG. 8, when the user is successfully verified, the server 400 must provide the server key 404 that corresponds to the access key 166 of the particular aerosol delivery device 102 to which the user wishes to connect. In order to do this, the mobile device 300 provides, to the server 400, data identifying the aerosol delivery device 102. In the embodiment of FIG. 8, the storage 402 is searched for a server key 404 that is associated with the aerosol delivery device 102 identified by the data. That server key 404 is then returned to the mobile device 300.

However, where access keys are allocated as per the process described with respect to FIG. 9, this storage (and searching) of access keys is not necessary. Rather, the data identifying the aerosol delivery device 102 comprises the UIK of the aerosol delivery device 102, which can be used to determine the corresponding access key 186. That is, rather than storing server keys for each aerosol delivery device 102 produced (or in circulation), the server 400 only requires access to the common mapping function (discussed with respect to FIG. 9) in order to return the correct server key 404.

While exemplary embodiments have been described above, many equivalent modifications and variations will be apparent to those skilled in the art when given this disclosure. Accordingly, the exemplary embodiments set forth above are considered to be illustrative and not limiting.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, ±10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

1. An aerosol delivery device comprising:
a communication interface configured to communicate with a mobile device (300);
a user interface configured to receive a user input sequence;
a memory configured to store an access key; and
a controller configured to compare a user input sequence received by the user interface with the stored access key, and control communication between the aerosol delivery device and the mobile device based on the comparison, wherein controlling communication with the mobile device comprises restricting communication with the mobile device,
wherein the communication interface is configured to receive requests from the mobile device and wherein restricting communication with the mobile device comprises not acting on a request received from the mobile device.

2. (canceled)

3. An aerosol delivery device according to claim 1 wherein the user interface is configured to indicate to a user that communication with a mobile device has been permitted or restricted.

4. An aerosol delivery device according to claim 1, wherein restricting communication comprises restricting communication of data from the aerosol delivery device to the mobile device.

5. An aerosol delivery device according to claim 1 wherein restricting communication comprises restricting control of the aerosol delivery device by the mobile device.

6. An aerosol delivery device according to claim 1 wherein the user interface comprises an accelerometer.

7. An aerosol delivery device according to claim 1 wherein the user interface comprises a touch sensor.

8. An aerosol delivery device according to claim 1 wherein the stored access key is representative of a movement of the aerosol delivery device .

9. An aerosol delivery device according to claim 1 wherein the stored access key is representative of a sequence of taps on the aerosol delivery device by a user.

10. A device access system for managing access to an aerosol delivery device, the system comprising:
an aerosol delivery device configured to communicate with a mobile device, the aerosol delivery device comprising a controller configured to control communication with the mobile device based on a comparison between a user input and an access key that is stored by the aerosol delivery device; and
a server configured to store a server key that corresponds to the access key of the aerosol delivery device, the server further configured to receive user verification data, determine whether the user verification data meets a user verification criteria, and provide the server key, upon request, if the user verification data meets the user verification criteria.

11. A system according to claim 10 wherein the user verification data is indicative of a user's age and the user verification criteria comprises a minimum user age.

12. (canceled)

13. (canceled)

14. (canceled)

15. (canceled)

16. An aerosol delivery device comprising:
a communication interface configured to communicate with a mobile device;
a user interface configured to receive a user input sequence;
a memory configured to store an access key; and
a controller configured to compare a user input sequence received by the user interface with the stored access key, and control communication between the aerosol delivery device and the mobile device based on the comparison,
wherein the user interface comprises a touch sensor.

17. An aerosol delivery device according to claim 16 wherein controlling communication with the mobile device comprises permitting and/or restricting communication with the mobile device.

18. An aerosol delivery device according to claim 17 wherein the user interface is configured to indicate to a user that communication with a mobile device has been permitted or restricted.

19. An aerosol delivery device according to claim 17 wherein restricting communication comprises restricting communication of data from the aerosol delivery device to the mobile device.

20. An aerosol delivery device according to claim 16 wherein restricting communication comprises restricting control of the aerosol delivery device by the mobile device.

21. An aerosol delivery device according to claim 16 wherein the user interface comprises an accelerometer.

22. An aerosol delivery device according to claim 16 wherein the stored access key is representative of a movement of the aerosol delivery device.

23. An aerosol delivery device according to claim 16 wherein the stored access key is representative of a sequence of taps on the aerosol delivery device by a user.

24. An aerosol delivery device according to claim 23 wherein the touch sensor is configured to detect the sequence of taps on the aerosol delivery device.
